(19) United States
(12) Patent Application Publication
(10) Pub. No.: US 2022/0324753 A1
(43) Pub. Date: Oct. 13, 2022

(54) REDUCING THE CORROSION OF SILVER WIRES ON A GLASS SUBSTRATE

(71) Applicant: SAINT-GOBAIN GLASS FRANCE, COURBEVOIE (FR)

(72) Inventors: Philippe LETOCART, RAEREN (BE); Antje JUNG, DÜREN (DE)

(21) Appl. No.: 17/634,815

(22) PCT Filed: Aug. 11, 2020
(86) PCT No.: PCT/EP2020/072519

§ 371 Date: Feb. 11, 2022

(30) Foreign Application Priority Data
Aug. 13, 2019 (EP) 19191361.5

(51) Int. Cl. C03C 17/22; B05D 7/24; C03C 23/00; C03C 17/30; B60J 1/18; H05B 3/84

(52) U.S. Cl. CPC C03C 17/22; B05D 7/24; C03C 23/007; C03C 17/30; B60J 1/18; H05B 3/84; B05D 2203/35

(57) ABSTRACT

A vehicle pane includes a glass substrate with elemental silver applied thereon discontinuously, as one or a plurality of lines, wherein the elemental silver has a coating that contains a thiol and/or a silicone resin and/or a silicate.

The invention relates to measures for preventing or reducing the corrosive discoloration of silver-based wires on a glass substrate in vehicle panes, and in particular to protective coatings applied for this purpose. The invention further relates to vehicle panes with corresponding coatings, methods for their production, and the use of coating materials for producing vehicle panes.

Rear windows of motor vehicles are currently usually equipped with electrical heating elements for heating the rear windows, Rear window heating of a motor vehicle is used, in particular, in the cold season to de-fog or de-ice the rear window,

Today's standard model of a window heater consists of multiple heating wires applied, i.e., for example, printed, on the window, which are usually applied horizontally on the window and are electrically connected to one another at their ends via bus bars. During operation, current is conducted via these bus bars, with the resistance of the heating wires generating heat which then heats the window. This type of window heater was developed at Ford Motor Company in the late 1960s and was first installed in series production in vehicles in 1974. Often used as the conductive material in these heating systems is elemental silver, which, as a noble metal, has the best possible electrical conductivity and ensures the least possible light shading. From the side on which the silver is applied on the glass pane, the silver is perceived as black or gray, whereas, from the other side of the glass pane, an orange color impression can also be created due to the interaction of the silver and partial penetration of the silver into the glass surface.

In another variant of the rear window heater, the wires are not printed on, but, instead, are situated between the two layers of a laminated glass pane.

DE 100 18 276 A1 discloses a laminated pane with electrically conductive wires embedded in a thermoplastic adhesive layer, with the wires consisting of at least two conductive material layers.

In the case of a heating system printed exclusively on the pane, in which the conductor tracks contain elemental silver, a partial, surface yellow or brown discoloration of the heating wires can develop over a relatively long period of time. The often uneven discoloration of the heating conductors is accompanied by a loss in the aesthetics of the pane. Moreover, the users of the vehicle may feel that the function of the wires is impaired. In order to avoid such uncertainties about the functionality of the heating system, there was a need for measures and a system with which discoloration of the heating wires in window heaters can be reduced or completely prevented.

US 2011/074796 A1 discloses a rear window with heating wires that has a protective film that at least partially covers the heating wires.

WO 2005/117494 A1 discloses vehicle rear windows made of polycarbonate with a heating system and a protective coating made of a silicone hard coat.

The present invention addresses the need for measures and a system with which undesirable discoloration of the heating wires in window heaters can be reduced or completely prevented.

Surprisingly, in the investigations on which this application is based, it was found that the aforementioned discoloration of the silver in heating wires of window heaters is caused by the surface oxidation of the silver, in which Ag₂S is formed by the action of hydrogen sulfide that can be present in very small amounts in the ambient air. The product formed as Ag₂S is responsible for the yellow or brown coloration observed on the wires. Based on these findings, this application proposes a coating for the elemental silver in the heating wires and cables of a window heater. Such a coating protects the elemental silver in the heating wires and heating cables in particular against undesirable discoloration.

Consequently, according to a first aspect, the present invention relates to vehicle pane at least comprising a glass substrate having elemental silver discontinuously applied thereon, wherein the elemental silver has a coating. The coating can contain a thiol and/or a silicone resin and/or a silicate. The coating is in particular a coating that protects against discoloration.

The term “discontinuously” refers to the fact that the elemental silver is applied not over the entire surface and not as a uniform region on the pane, but rather in such a way that non-coated regions are situated between individual coated regions. For example, the silver can be applied on the glass substrate in the form of multiple strips or lines between which there are non-coated regions of the glass substrate. The strips or lines can be connected only at their ends to strips formed, for example, as bus bars; however, it is also possible for the strips or lines to intersect or for there to be additional strips that cross multiple other strips or lines at one or more points (e.g., in the case of antennas formed by the strips and lines). Preferably, the elemental silver is applied on the glass substrate as one or a plurality of lines or tracks. In the context of the present invention, the lines applied are also referred to as “wires”,

The indication that the glass substrate is to “have elemental silver applied thereon” is understood to mean that the glass substrate has, in the relevant regions, a coating that contains elemental silver but is not necessarily made exclusively thereof.

In the invention described here, the term “applied” includes application of the silver using methods readily known to the person skilled in the art, including printing methods such as screen printing, inkjet printing, aerosol printing, gravure printing, or flexographic printing, but also methods by which the silver is pressed onto the substrate as an extruded paste.

The term “wherein the elemental silver has a coating” is in particular understood to mean that a coating is applied at least on the elemental silver discontinuously applied preferably as one or a plurality of lines or tracks, i.e., that at least the elemental silver discontinuously applied, preferably as one or plurality of lines or tracks, is covered with a coating.

The indication that “vehicle pane comprises at least a glass substrate” is understood in particular to mean that the vehicle pane is implemented as a single pane made of a glass substrate.

Alternatively, the vehicle pane can be implemented as a laminated glass made of a glass substrate and another glass pane bonded together via a thermoplastic intermediate layer.

Preferably, the vehicle pane is a rear window. Furthermore, it is preferred for the glass forming the glass substrate to be a heat-treated and preferably a tempered glass. Such glasses are available, for example, under the tradename Sekurit from Saint-Gobain and are produced by quenching a pane heated to about 600° C. with a stream of cold air. This creates strong compressive stresses in the surface that significantly increase the bending strength and, among other things, the thermal shock resistance of the glass.

The glass substrate is preferably made of soda lime glass, as is common for window panes, but can also include other types of glass, such as borosilicate glass, aluminosilicate glass, or quartz glass. The thickness of the glass substrate is typically from 0.5 mm to 10 mm, preferably 1 mm to 5 mm.

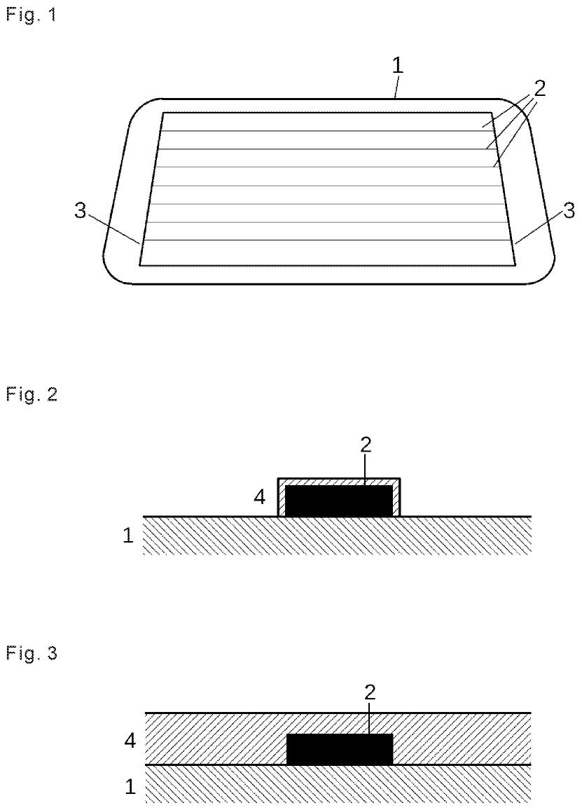

For the elemental silver applied on the glass substrate of the vehicle pane, it is preferable for it to be applied as a plurality of lines that are connected to one another at their ends. Such a configuration of the applied silver, as depicted in FIG. 1, is a prerequisite for incorporating the vehicle pane into a heating apparatus with which the vehicle pane can be heated. In another preferred embodiment, the plurality of lines applied on the glass substrate of the vehicle pane are part of a heating system. Such heating systems usually have, in addition to the lines, connection elements for the lines by means of which the individual lines can be connected to a current source and a control system by means of which the connection to the power source can be activated or deactivated.

The invention is not limited to heating systems; the silver can also form conductor tracks of sensors, antennas, or similar technical devices.

The term “lines” is used in the present invention synonymously with “tracks” and means a structure that extends substantially farther in its length than in its width and thickness, i.e., the length of the structure is preferably greater at least by a factor of 100 and particularly preferably at least by a factor of 250 than the width and the thickness of the structure.

The term “plurality” preferably means at least 3 and in particular at least 5 lines, and/or preferably at most 20 and in particular at most 15 lines.

If the glass substrate of the vehicle pane has a plurality of of lines, the area covered by the lines should be as small as possible, i.e., not more than 5% and in particular not more than 2% of the entire area of the glass substrate should be covered by the lines. On the other hand, the lines should be distributed as homogeneously as possible over the entire area of the glass substrate, e.g., in such a way that the lines, including the area of the glass substrate situated between the lines, cover a total fraction of the glass substrate of at least 60%, preferably at least 70%, and particularly preferably at least 80%.

Alternatively, the glass substrate of the vehicle pane can have a single line, which preferably extends in a serpentine manner substantially overthe entire area of the glass substrate (i.e;, over at least 60%, preferably at least 70%, and particularly preferably at least 80% of the area).

With regard to the thickness of the lines, the present invention is not subject to any relevant restrictions, although the thickness should be as thin as possible such that it not be perceived by the user as distracting and limiting the field of view; on the other hand, the lines should, however, be sufficiently thick that the function of the lines, e.g., as heating wires, is not adversely affected. A range from 1 to 200 μm (microns), in particular 5 to 100 μm, and most particularly preferably in the range from about 20 to 50 μm can be specified as suitable for the thickness of the lines. In particular preferred cases, a thickness in the range from 10 to 20 μm can also be realized.

The width of the lines is likewise not subject to any relevant restrictions, although, here as well, the least possible width is preferable in order not to distractingly reduce the field of vision more than necessary. Preferably, the lines are 10 μm to 1 cm wide and more preferably 100 μm to 2 mm wide.

Preferably, in the context of the invention, the coating itself does not alter the visual impression of the elemental silver situated on the glass substrate. Accordingly, colored coatings are preferably excluded in the context of the present invention.

A suitable coating agent is a coating agent that contains a thiol. Such thiols can effectively passivate silver surfaces. This can result in a color impression which, although it differs from the color impression of the silver before treatment with thiols, is uniform/homogeneous, stable, and changes no more over the further period of use of the coated substrate. Thiols also have the advantage that due to the Ag—S interaction, they are selectively absorbed only on the silver surface.

One suitable class of thiols that can be readily processed is, for example, thiocarboxylic acids, which are applied in aqueous emulsion and adhere well to the silver surface. Thiocarboxylic acids have the advantage that they can be formulated as an aqueous emulsion without an emulsifier because thiocarboxylic acids have a hydrophilic carboxyl group, which even makes them partially water-soluble. On the other hand, aqueous emulsions of thiocarboxylic acids have only a short shelf life and their handling is difficult.

Another class of suitable thiols are longer chain (i.e., having at least 6 C atoms) hydrophobic thiols or their esterification products without hydrophilic carboxyl groups.

Such thiols have the advantage not only of an adequate protective effect against oxidative discoloration, but can also be used as an aqueous emulsion. This type of application is described in detail, for example, in EP 0 492 487 B1.

Particularly preferred are hydrophobic aliphatic thio compounds with at least 12 C atoms in the chain, and most particularly preferred are hydrophobic aliphatic thio compounds with at most 20 C atoms in the chain. With fewer than 12 C atoms, in individual cases, it may be impossible to achieve a protective coating with good adhesion, or there may be a strong odor nuisance. Hydrophobic aliphatic thio compounds with more than 20 C atoms are, in contrast, so solid in their consistency and, in some cases, cannot be processed as emulsions without organic solvents, making application of the thiols technically difficult. A hydrophobic aliphatic thio compound that is most particularly preferred in this context is hexadecanethiol.

The thiols indicated above are in particular advantageous because they can be emulsified very finely, with long-term stability, and can be applied to the surfaces to be protected in a thin but dense layer. For this, emulsifiers can optionally be added, such as, in particular, fatty alcohols with 9 to 20 C atoms, preferably with 10 to 15 C atoms, with the branched fatty alcohols preferably being alkoxylated, in particular ethoxylated, and having a degree of alkoxylation of 2 to 10.

For the thiol-based coating agents, a pH of 1-10 is expedient, a pH of 1-8 preferable, and a pH of 2-4 particularly preferable, since at this pH, the emulsifier can be largely washed out of the deposited thiol layer completely with water, this being important for reliable surface protection, If the pH exceeds the specified range, less inhibitor is washed out, increasing the protective effect and the lubricating effect, but stains that interfere with the appearance can also develop on the surface. With a pH above 10, there is a risk of the emulsion splitting.

Since thiols react selectively with silver, about one molecular layer of thiols is usually deposited on the silver surface during a thiol treatment. The layer thickness of the thiol coating is thus usually determined by the chain length of the thiol and is usually less than 1 μm.

To fix the thiols on the silver, it is possible to overlay the coating with another agent which, for example, provides better resistance against mechanical action (scratching) and/or suppresses or prevents the thiols from being washed out.

Another suitable coating agent that is colorless and provides a beneficial protective effect for the elemental silver against oxidative discoloration is a coating agent that contains a silicone resin. Silicone resins also have the advantage of providing beneficial properties against abrasion, chemical agents, or UV-radiation.

Suitable silicone resins can, for example, be alkylated silicone resins such as those available as BECKOLITE M-6652-60 or M-6650-60 (each from Dainippon Ink and Chemicals Co., Ltd.), Baysilone Resin UD-460M or 180 (each from Bayer Co., Ltd.).

Silicone resins as described in JP 2012-056251 A are another suitable class of silicone resins.

Siloxane acrylic copolymers, as described in J PH-09/241532 A are another suitable class of silicone resins for suppressing oxidative discoloration of elemental silver.

Another suitable class of silicon resins for suppressing oxidative discoloration of elemental silver is described, for example, in WO 1999/062646 A1. Such silicone resins include, as a primary component, at least one resin type selected from the group consisting of a silicone acrylic resin, a silicone alkyd resin, and a multifunctional cross-linked silicone resin, wherein the multifunctional cross-linked silicone resin has an average composition formula of the formula RₙSiO_{(4-n)/2} and a number average molecular weight of 500-1000. In the formula, R represents a hydrogen atom, a lower alkyl group (C1-C6), a phenyl group, or a substituted phenyl group; n is a number from 1.2 to 1.4.

Silicone resins can be applied on the glass substrate of the vehicle pane such that only the silver situated on the glass substrate is covered by the silicone resin; however, it is also possible for the silicone resin to cover more than the silver situated on the glass substrate (i.e., for example, to cover an area that extends by 50% or 100% beyond the area covered by silver silver; in the case of silver applied as a line on the glass substrate, the coating is wider by, e.g., 50% or 100% than the width of the line). It is also possible for the silicone resin to cover the entire area of the glass substrate.

For coating compositions based on silicone resins, it can be advantageous for the coating composition to include, in addition to the silicone resin, a metal compound, preferably in a proportion of 0.01 to 5 parts by weight. A particularly suitable metal compound is, for example, a zinc salt or a zinc complex.

Preferred zinc salts include, in particular, zinc salts of carboxylic acids with 3 to 20 carbon atoms and phosphoric acid zinc salts; particularly preferred zinc salts are zinc salts of aliphatic saturated or unsaturated carboxylic acids such as, in particular, 2-ethylhexylcarboxylic acid, neodecanecarboxylic acid, lauric acid, ricinoleic acid, stearic acid, or undecylenecarboxylic acid. Particularly suitable zinc phosphoric acid salts are phosphoric acid zinc salts. Particularly suitable zinc complexes are zinc complexes with carbonyl compounds such as acetylacetonate.

It is believed that in the case of a coating composition containing such salts or complexes, any hydrogen sulfide penetrating into the coating is absorbed by the salts or complexes, thus converting them into zinc sulfide. As a result, the hydrogen sulfide can no longer penetrate all the way to the elemental silver beneath the coating.

Alternatively, or additionally, the coating composition can also contain zirconium salts or complexes, in particular zirconium complexes of carboxylic acids, preferably of lower carboxylic acids (C1 to C10, in particular C2 to C6), which can be substituted with a benzoyl or methylbenzene group. Zirconium complexes of 4-methyl-y-oxo-benzene-butanoic acid or of p-toluoyl-propanoic acid are particularly suitable in this context.

Optionally, the silicone composition can also contain customary additives, such as, in particular, condensation catalysts for the silicone resin, solvents, smoothing agents, coupling agents, foam suppressants, matting agents, UV absorbers, antioxidants, and the like, which are known to the person skilled in the art for such formulations.

A range of about 1 to 150 μm, preferably 5 to 100 μm, and particularly preferably 8 to 50 μm can be specified as a suitable thickness fora silicone coating.

The coating compositions described above can be applied to the glass substrate using conventional coating methods, such as dip coating or spray coating or gas phase coating. When coating with thiols, unbound thiol can subsequently be washed off the substrate.

Another suitable coating agent is silicate (SiOₓ with x˜2). Such a coating can be produced, for example, using a volatile silane precursor burned in a flame to form silicate, with the silicate from the flame being deposited directly onto material to be coated. Devices for applying such silicate coatings are available, for example, from the company Arcotech under the name FTM. In the case of a silicate coating, a very thin application of the coating is usually sufficient, with a coating thickness of approx. 10 to 50 nm and in particular 15 to 30 nm indicated as suitable.

According to a further aspect, the present invention relates to a vehicle pane that includes a system, in particular a heating system, formed by one or a plurality of wires comprising elemental silver, with at least the wire or wires being covered with a coating. Particularly useful coatings are those comprising a thiol and/or a silicone resin and/or silicate, as described in detail above. Most particularly preferred are coatings containing only one of these alternatives mentioned.

The vehicle pane can be designed such that the wires are situated on an externally accessible surface of the glass substrate implemented as a glass pane; however, it is also possible for the wires to be attached on a glass substrate as part of a laminated glass pane such that glass panes are situated above and below the wires. However, since such a construction is usually significantly more complex to produce and the problem of possible discolorations of the wires in interaction with components of the ambient air is less of an issue with laminated glass panes, it is preferable for the vehicle pane to have wires on an externally accessible area of the glass pane that are coated with the materials specified above. In this context, “an externally accessible area of the glass pane” means an area directly adjacent the vehicle interior or the external environment,

According to a further aspect, the present invention relates to a method for producing a vehicle pane, comprising at least the the following steps;
Providing a glass substrate that has a system applied thereon, in particular a heating system, formed from a wire or a plurality of wires that contain elemental silver,
Applying a coating comprising a thiol and/or a silicone resin and/or silicate to the wire or the plurality of wires, and
Optionally, curing the coating.

The application can be done expediently by spraying the coating or dipping in a solution containing the coating, by gas phase coating or by applying silicate by combustion of a suitable volatile precursor, as explained above. The coating composition that is applied comprises thiol and/or a silicone resin and/or silicate and particularly preferably a thiol and/or a silicone resin and/or silicate indicated above as particularly suitable. Particularly preferably, the coating composition comprises only one of the alternatives mentioned.

The glass substrate in the method described is expediently designed as a vehicle pane or as a precursor to a vehicle pane from which a vehicle pane can be produced by finishing. Steps required for this, e.g., curing, shaping, or bending, can can even be carried out with the coated glass substrate, provided this does not adversely affect the applied coating. Here, in particular, silicate-coated glass substrates in which the coating has the necessary thermal stability can be used.

Finally, a further aspect of the present invention relates to the use of a composition comprising a thiol and/or a silicone resin for the production of a vehicle pane that includes a system, in particular a heating system, that is formed from a wire or a plurality of wires comprising elemental silver, wherein the composition is applied to the wires as a protective coating. In the context of this use, the coating is applied in particular as a protective coating against discoloration. An analogous aspect relates to the use of a composition comprising a silicate precursor for the production of a vehicle pane that includes a system, in particular a heating system, that is formed from a wire or a plurality of wires comprising elemental silver, wherein silicate that is applied to the wires as a protective coating is produced from the composition by combustion.

The invention is explained in detail with reference to figures and exemplary embodiments. The drawings are schematic representations and not to scale. The figures in no way restrict the invention. They depict:

FIG. 1 a schematic viewof a vehicle pane implemented as a rear windowcomprising a glass substratel with a plurality of wires made of elemental silver2 applied thereon, which are connected to one another at their ends via common bus bars 3. According to the invention, at least the wires are provided with a coating.

FIG. 2 a schematic view of a cross-section of a wire made of elemental silver2 with a surface coating 4 made of thiols on a glass substrate 1. The wire is, for example, a heating wire,

FIG. 3 a schematic view of a cross-section of a wire made of elemental silver2 with a surface coating 4 made of silicone on a glass substrate 1, wherein the entire surface of the glass substrate 1 is covered with the silicone. The wire is, for example, a heating wire.

Overall, the implementation of the invention is not limited to the aspects highlighted above and the examples described above, but, rather, is also possible in a large number of variations that are within the scope of the appended claims.

1. A vehicle pane comprising a glass sub strate with elemental silver applied thereon discontinuously as one or a plurality of lines, wherein the elemental silver has a coating that contains a thiol and/or a silicone resin and/or a silicate.

2. The vehicle pane according to claim 1, having the form of a rear window.

3. The vehicle pane according to claim 1, wherein the silver is applied as a plurality of lines that are connected to one another at their ends.

4. The vehicle pane according to claim 3, wherein the plurality of lines form part of a heating system.

5. The vehicle pane according to claim 1, wherein the elemental silver applied as one or a plurality of lines forms one or a plurality of conductor tracks of at least one sensor or at least one antenna.

6. The vehicle pane according to claim 1, wherein the coating contains a thiol.

7. The vehicle pane according to claim 1, wherein the coatingcontains a silicone resin.

8. The vehicle pane according to claim 7, wherein the coating additionally contains one or more of a zinc salt, a zinc complex, a zirconium salt, and a zirconium complex.

9. The vehicle pane according to claim 1, wherein the coating contains silicate.

10. The vehicle pane according to claim 1, wherein the glass substrate is a heat-treated glass.

11. The vehicle pane according to claim 1, wherein the coating is applied only on the elemental silver.

12. The vehicle pane according to claim 1, wherein the coating is applied substantially over an entire surface of the vehicle pane.

13. A method for producing a vehicle pane according to claim 1, comprising:
providing a glass substrate that has a system applied thereon formed from one or a plurality of wires that contain elemental silver,
applying a coating that comprises a thiol and/or a silicone resin and/or silicate on the one or the plurality of wires, and
optionally, curing the coating.

14. A method comprising manufacturing a vehicle pane that includes a system formed from one or a plurality of wires comprising elemental silver, the manufacturing comprising applying a composition on the wires as a coating, the composition comprising a thiol and/or a silicone resin.

15. A method comprising manufacturing a vehicle pane that includes a system formed from one or a plurality of wires comprising elemental silver, wherein silicate that is applied on the wires as a coating is produced from a composition by combustion, the composition comprising a silicate precursor.

16. The vehicle pane according to claim 6, wherein the thiol is an aliphatic C12 to C20 thiol.

17. The vehicle pane according to claim 7, wherein the silicone resin is an alkylated silicone resin.

18. The vehicle pane according to claim 9, wherein the coating is made of silicate.

19. The vehicle pane according to claim 10, wherein the glass substrate is a tempered glass.

20. The method according to claim 14, wherein the coating is a protective coating against discoloration.
